(19) United States
(12) Patent Application Publication
(10) Pub. No.: US 2024/0249861 A1
(43) Pub. Date: Jul. 25, 2024

(54) CERAMIC ELECTRONIC COMPONENT

(71) Applicant: Murata Manufacturing Co., Ltd., Kyoto (JP)

(72) Inventor: Hirofumi OIE, Nagaokakyo-shi (JP)

(21) Appl. No.: 18/624,567

(22) Filed: Apr. 2, 2024

Related U.S. Application Data
(63) Continuation of application No. PCT/JP2022/035733, filed on Sep. 26, 2022.

(30) Foreign Application Priority Data
Oct. 26, 2021 (JP) 2021-174876

(51) Int. Cl. H01C 1/04

(52) U.S. Cl. CPC H01C 1/04

(57) ABSTRACT

To provide ceramic electronic component capable of suppressing breakage of identification mark and element body and intrusion of liquid into element body. Ceramic electronic component includes element body including ceramic as main material, barrier layer formed on surface of element body and including ceramic as main material, and identification mark formed on surface of barrier layer. Element body, barrier layer, and identification mark include glass material. Proportion of glass material included in barrier layer is higher than proportion of glass material included in element body.

### CROSS REFERENCE TO RELATED APPLICATION

This is a continuation of International Application No. PCT/JP2022/035733 filed on Sep. 26, 2022, which claims priority from Japanese Patent Application No. 2021-174876 filed on Oct. 26, 2021. The contents of these applications are incorporated herein by reference in their entireties.

### BACKGROUND OF THE DISCLOSURE

### Field of the Disclosure

The present disclosure relates to a ceramic electronic component including an element body including ceramic as a main material and an identification mark formed in the element body.

### Description of the Related Art

Patent Document 1 discloses an example of a ceramic electronic component including an element body including ceramic as a main material and an identification mark formed in the element body.

The chip-type electronic component disclosed in Patent Document 1 includes the element body and the identification mark formed on a surface of the element body. The element body includes a ceramic material containing ZnO as a main component. The identification mark is for identifying a vertical direction of the chip-type electronic component. The identification mark includes ZrO₂.
Patent Document 1: JP 4276233 B2

### SUMMARY

When the composition of the constituent material is different between the element body and the identification mark as in the chip-type electronic component disclosed in Patent Document 1, diffusion from the identification mark to the element body occurs. In particular, since a tendency of diffusion of ZrO₂ into the ceramic is strong, the diffusion of the identification mark into the element body becomes large. When diffusion occurs, cracks may occur in the element body and the identification mark, or the identification mark may be detached from the element body. When diffusion occurs, sinterability of the element body is deteriorated, the number of voids in the element body increases, and there is a risk that liquid enters the element body through the voids.

Usually, in order to ensure visibility of the identification mark, an inorganic component and a composition ratio of the identification mark are different from an inorganic component and a composition ratio of the element body. Therefore, since the sinterability of the identification mark and the sinterability of the element body are different, optimum sintering temperatures of the identification mark and the element body are different. In this case, the sinterability of the element body is prioritized over the sinterability of the identification mark at the time of sintering in a process of manufacturing the ceramic electronic component. That is, the ceramic electronic component is sintered at the optimum sintering temperature for the element body. Therefore, there is a possibility that the identification mark is insufficiently sintered or excessively sintered. When the identification mark is insufficiently sintered, the number of voids in the identification mark increases, and there is a possibility that the liquid enters the element body through the voids. When the identification mark is excessively sintered, the identification mark becomes excessively dense, and stress acts on the element body from the identification mark to generate a crack in the element body.

Therefore, a possible benefit of the present disclosure is to solve the above problems, and to provide a ceramic electronic component capable of suppressing breakage of an identification mark and an element body and intrusion of liquid into the element body.

In order to achieve the above possible benefit, the present disclosure is configured as follows. A ceramic electronic component according to one embodiment of the present disclosure includes: an element body including ceramic as a main material; a barrier layer formed on a surface of the element body and including ceramic as a main material; and an identification mark formed on a surface of the barrier layer, in which the element body and the barrier layer include a glass material, and a proportion of the glass material included in the barrier layer is higher than a proportion of the glass material included in the element body.

The present disclosure can suppress breakage of the identification mark and the element body and intrusion of liquid into the element body.

### BRIEF DESCRIPTION OF THE SEVERAL VIEWS OF THE DRAWINGS

FIG. 1 is a plan view of a ceramic electronic component according to a first embodiment of the present disclosure;

FIG. 2 is a sectional view illustrating a cross section taken along line A-A in FIG. 1;

FIG. 3 is a sectional view when an interlayer connection conductor is formed on a substrate in a process of manufacturing the ceramic electronic component according to the embodiment of the present disclosure;

FIG. 4 is a sectional view when an internal electrode is printed on the substrate in the process of manufacturing the ceramic electronic component according to the embodiment of the present disclosure;

FIG. 5 is a sectional view when a barrier layer is printed on the substrate in the process of manufacturing the ceramic electronic component according to the embodiment of the present disclosure;

FIG. 6 is a sectional view when an identification mark is printed on the barrier layer in the process of manufacturing the ceramic electronic component according to the embodiment of the present disclosure;

FIG. 7 is a sectional view when a plurality of substrates are stacked to form an element body in the process of manufacturing the ceramic electronic component according to the embodiment of the present disclosure;

FIG. 8 is a sectional view when the element body is crimped in the process of manufacturing the ceramic electronic component according to the embodiment of the present disclosure;

FIG. 9 is a sectional view of a plurality of stacked substrates and a film on which a barrier layer and an identification mark are printed in a modification of the process of manufacturing the ceramic electronic component according to the embodiment of the present disclosure;

FIG. 10 is a sectional view corresponding to the cross section taken along line A-A of FIG. 1 in a ceramic electronic component according to a second embodiment of the present disclosure; and

FIG. 11 is a sectional view corresponding to the cross section taken along line A-A of FIG. 1 in a ceramic electronic component according to a third embodiment of the present disclosure.

### DETAILED DESCRIPTION OF THE DISCLOSURE

A ceramic electronic component according to one embodiment of the present disclosure includes: an element body including ceramic as a main material; a barrier layer formed on a surface of the element body and including ceramic as a main material; and an identification mark formed on a surface of the barrier layer, in which the element body and the barrier layer include a glass material, and a proportion of the glass material included in the barrier layer is higher than a proportion of the glass material included in the element body.

In this configuration, the barrier layer is interposed between the element body and the identification mark. As a result, the barrier layer can prevent a diffusion of the identification mark from reaching the element body. In addition, the action of stress from the identification mark to the element body can be absorbed by the barrier layer.

In this configuration, both the element body and the barrier layer include ceramic as a main material. Therefore, the action of diffusion and stress between the barrier layer and the element body can be reduced. As a result, the possibility of occurrence of cracks in the barrier layer and the element body and detachment of the barrier layer from the element body can be reduced.

In this configuration, the proportion of the glass material included in the barrier layer is higher than the proportion of the glass material included in the element body. Therefore, the barrier layer can be sintered more densely than the element body. As a result, an entry of a liquid into the element body starting from the identification mark can be reduced by the barrier layer.

In the ceramic electronic component, an outer edge portion of the identification mark may be inside of an outer edge portion of the barrier layer when viewed from an orthogonal direction orthogonal to a surface of the element body on which the barrier layer is formed.

When the shape and size of the identification mark and the barrier layer are the same as viewed from the orthogonal direction orthogonal to the surface of the element body on which the barrier layer is formed, that is, when the outer edge portion of the identification mark and the outer edge portion of the barrier layer are at the same position as viewed from the orthogonal direction, the outer edge portion of the identification mark is located near the surface of the element body. This configuration increases the possibility that the diffusion of the identification mark reaches the element body, the possibility that the stress of the identification mark acts on the element body, and the possibility that the liquid attached to the identification mark reaches the element body. In this configuration, the outer edge portion of the identification mark is located inside of the outer edge portion of the barrier layer when viewed from the orthogonal direction. As a result, since the outer edge portion of the identification mark is distant from the surface of the element body, the possibility can be reduced.

In the ceramic electronic component, a main material of the identification mark may be ceramic.

In this configuration, both the main material of the identification mark and the main material of the barrier layer are ceramics. Therefore, adhesion of the identification mark to the barrier layer can be enhanced. As a result, the possibility of detachment of the identification mark from the barrier layer can be reduced.

In the ceramic electronic component, the porosity of the barrier layer may be lower than the porosity of the element body.

In this configuration, since the porosity of the barrier layer is lower than the porosity of the element body, it is possible to suppress the entry of the liquid into the element body starting from the identification mark in the barrier layer.

In the ceramic electronic component, the main material of the barrier layer may be the same as the main material of the element body.

In this configuration, the main material of the barrier layer is the same as the main material of the element body. Therefore, the adhesion of the barrier layer to the element body can be enhanced as compared with a configuration in which the main material of the barrier layer is different from the main material of the element body.

In the ceramic electronic component, at least a part of the barrier layer may protrude from the surface of the element body.

In this configuration, the distance between the identification mark and the element body can be increased in the orthogonal direction orthogonal to the surface of the element body on which the barrier layer is formed as compared with the configuration in which the barrier layer does not protrude from the surface of the element body. It is therefore possible to reduce the possibility that the diffusion of the identification mark reaches the element body, the possibility that the stress of the identification mark acts on the element body, and the possibility that the liquid attached to the identification mark reaches the element body.

In the ceramic electronic component, at least a part of the identification mark may protrude from the surface of the barrier layer.

In this configuration, the distance between the identification mark and the element body can be increased in the orthogonal direction orthogonal to the surface of the element body on which the barrier layer is formed as compared with the configuration in which the identification mark does not protrude from the surface of the barrier layer. It is therefore possible to reduce the possibility that the diffusion of the identification mark reaches the element body, the possibility that the stress of the identification mark acts on the element body, and the possibility that the liquid attached to the identification mark reaches the element body.

In the ceramic electronic component, the identification mark may include a glass material.

In this configuration, the identification mark includes a glass material. Therefore, sinterability of the identification mark can be enhanced. As a result, it is possible to reduce the entry of liquid into the identification mark.

In the ceramic electronic component, the glass material included in the element body, the glass material included in the barrier layer, and the glass material included in the identification mark may be of the same type.

When the glass material included in the element body and the glass material included in the barrier layer are of different types, glass is absorbed from one of the element body or the barrier layer to the other. Similarly, when the glass material included in the barrier layer and the glass material included in the identification mark are of different types, glass is absorbed from one of the barrier layer or the identification mark to the other. As a result, diffusion between the element body, the barrier layer, and the identification mark is promoted. In this configuration, the glass material included in the element body, the glass material included in the barrier layer, and the glass material included in the identification mark are of the same type. Therefore, the diffusion can be suppressed.

In the ceramic electronic component, the identification mark may include a coloring material.

In this configuration, the identification mark can have a different color from the barrier layer and the element body by the coloring material. Therefore, visibility of the identification mark can be enhanced.

### First Embodiment

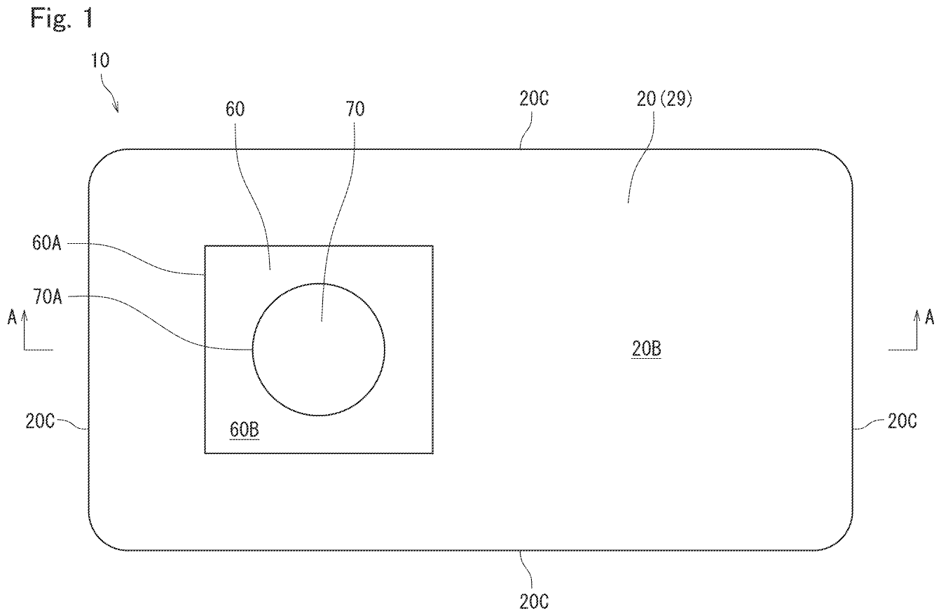

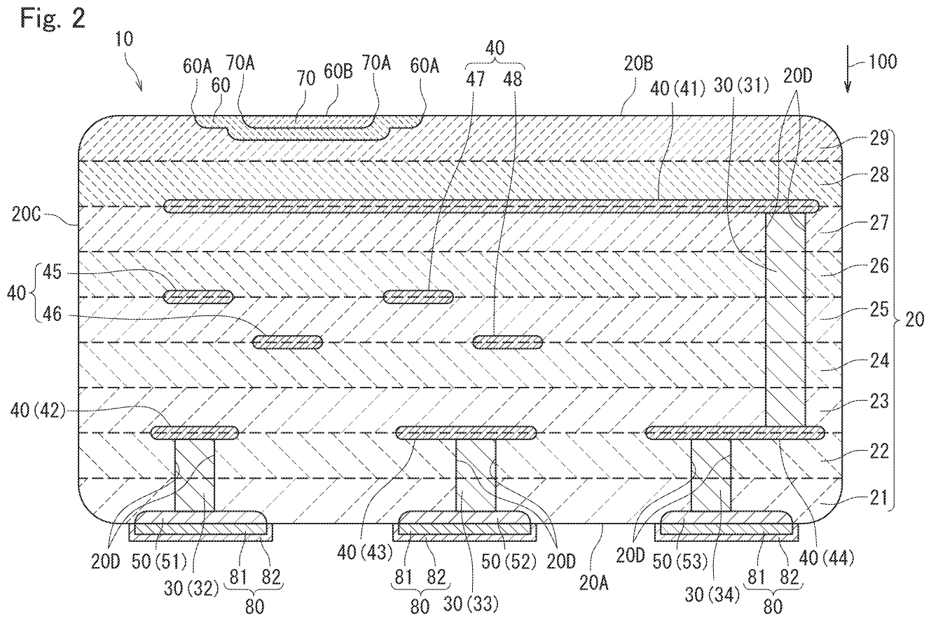

FIG. 1 is a plan view of a ceramic electronic component according to a first embodiment of the present disclosure. FIG. 2 is a sectional view illustrating a cross section taken along line A-A in FIG. 1. In the ceramic electronic component, a barrier layer and an identification mark are provided on an element body. In the ceramic electronic component according to the first embodiment, in addition to the barrier layer and the identification mark, an internal electrode, an external electrode, and a plating layer are provided on the element body. The ceramic electronic component can be mounted on a motherboard or the like via the external electrode.

As illustrated in FIGS. 1 and 2, a ceramic electronic component 10 according to the first embodiment includes an element body 20, an interlayer connection conductor 30, an internal electrode 40, an external electrode 50, a barrier layer 60, an identification mark 70, and a plating layer 80.

The element body 20 has a rectangular parallelepiped shape as a whole. The shape of the element body 20 is not limited to a rectangular parallelepiped shape. In the first embodiment, the element body 20 is formed by integrating substrates 21 to 29 stacked in a thickness direction 100. That is, in the first embodiment, the element body 20 is formed by integrating nine substrates. The number of substrates constituting the element body 20 is not limited to nine. Each of the substrates 21 to 29 is insulating and has a plate shape.

The element body 20 includes ceramic as a main material. The main material of the element body 20 is a material having the highest proportion among the plurality of types of materials included in the element body 20. When the element body 20 includes one kind of material, the one kind of material constituting the element body 20 is the main material of the element body 20. The definition of the main material is the same for other than the element body 20. For example, a main material of the barrier layer 60 is a material having the highest proportion among a plurality of types of materials included in the barrier layer 60, and a main material of the identification mark 70 is a material having the highest proportion among a plurality of types of materials included in the identification mark 70.

In the first embodiment, the element body 20 (each of the substrates 21 to 29) is a main material and includes a filler for determining dielectric properties, a glass material, and an additive for adjusting physical properties such as shrinkage rate. The proportion of each material included in the element body 20 is about 60% for the filler, about 10% for the glass material, and about 30% for the additive. The filler and the additive include aluminum (Al), magnesium (Mg), silicon (Si), barium (Ba), titanium (Ti), and the like.

As long as a condition that the main material is ceramic is satisfied, the material included in the element body 20 is not limited to the above materials, and the proportion of each material included in the element body 20 is not limited to the above proportion. The filler and the additive may include substances other than the above substances.

As illustrated in FIG. 2, the element body 20 includes a pair of main surfaces 20A and 20B and a side surface 20C. The main surface 20A is a main surface of the substrate 21 and faces an outside of the element body 20. The main surface 20B is a main surface of the substrate 29 and faces the outside of the element body 20. The main surface 20B faces an opposite side of the main surface 20A. The main surface 20B is an example of a surface of the element body 20. The side surface 20C is configured by side surfaces of the substrates 21 to 29. The side surface 20C connects the main surfaces 20A and 20B.

In the first embodiment, the pair of main surfaces 20A and 20B is orthogonal to the thickness direction 100. The plan view of FIG. 1 is a diagram of the ceramic electronic component 10 when viewed in the thickness direction 100 (see FIG. 2). The thickness direction 100 is an example of an orthogonal direction.

As illustrated in FIG. 2, the interlayer connection conductor 30 is formed inside the element body 20. The interlayer connection conductor 30 can be formed in at least one of the substrates 21 to 29. In the first embodiment, the interlayer connection conductor 30 is formed in the substrates 21 to 27.

The interlayer connection conductor 30 is obtained by filling a through hole 20D penetrating at least one of the plurality of substrates 21 to 29 in the thickness direction 100 with a conductive paste, and co-firing the conductive paste with the element body 20 including ceramic as a main material. The conductive paste includes, for example, a conductive powder of copper or the like. The conductive powder included in the conductive paste is not limited to copper, and may be, for example, silver. In the first embodiment, since the through hole 20D has a cylindrical shape, the interlayer connection conductor 30 has a cylindrical shape. The shape of the through hole 20D is not limited to a cylindrical shape, and may be, for example, a shape such as a quadrangular prism.

In FIG. 2, the interlayer connection conductor 30 includes four interlayer connection conductors 31 to 34. The interlayer connection conductor 31 is filled in the through hole 20D penetrating the substrates 23 to 27. The interlayer connection conductors 32 to 34 are filled in the through hole 20D penetrating the substrates 21 to 22. The length of each interlayer connection conductor 31 to 34 in the thickness direction 100 (the number of substrates penetrated) is not limited to the length described above.

The internal electrode 40 is formed inside the element body 20 and is not exposed to the outside of the element body 20. The internal electrode 40 can be formed in at least one of the substrates 21 to 29. In the first embodiment, the internal electrode 40 is formed in the substrates 23, 25, 26, and 28.

When the main material of the element body 20 is ceramic as in the first embodiment, the internal electrode 40 is obtained by printing a conductive paste on the main surface of the substrate (substrates 23, 25, 26, and 28 in the first embodiment) and co-firing the conductive paste with the substrate. The conductive paste includes, for example, copper or silver.

In the first embodiment, the internal electrode 40 includes eight internal electrodes 41 to 48. The internal electrode 41 is formed in the substrate 28. The internal electrodes 42 to 44 are formed in the substrate 23. The internal electrodes 45 and 47 are formed in the substrate 26. The internal electrodes 46 and 48 are formed in the substrate 25.

Each of the internal electrodes 40 is electrically connected to another internal electrode 40 or the external electrode 50. In the first embodiment, as illustrated in FIG. 2, the internal electrode 41 is electrically connected to the internal electrode 44 via the interlayer connection conductor 31. The internal electrode 42 is electrically connected to the external electrode 51 via the interlayer connection conductor 32. The internal electrode 43 is electrically connected to the external electrode 52 via the interlayer connection conductor 33. The internal electrode 44 is connected to the internal electrode 41 via the interlayer connection conductor 31, and is electrically connected to the external electrode 53 via the interlayer connection conductor 34.

The external electrode 50 is formed outside of the element body 20. That is, the external electrode 50 is exposed to the outside of the element body 20. In the first embodiment, the external electrode 50 is formed on the main surface of the substrate 21 (the main surface 20A of the element body 20). Note that the external electrode 50 may be formed on at least one of the main surface 20B of the element body 20 or the side surface 20C of the element body 20 instead of the main surface 20A of the element body 20 or in addition to the main surface 20A of the element body 20.

The external electrode 50 is configured similarly to the internal electrode 40. That is, in the first embodiment, the external electrode 50 is provided on the main surface 20A of the element body 20. In the first embodiment, the external electrode 50 includes three external electrodes 51 to 53.

As described above, the external electrode 51 is electrically connected to the internal electrode 42 via the interlayer connection conductor 32, the external electrode 52 is electrically connected to the internal electrode 43 via the interlayer connection conductor 33, and the external electrode 53 is electrically connected to the internal electrode 44 via the interlayer connection conductor 34.

As illustrated in FIGS. 1 and 2, the barrier layer 60 is formed outside of the element body 20. That is, the barrier layer 60 is exposed to the outside of the element body 20. In the first embodiment, the barrier layer 60 is formed on the main surface of the substrate 29 (the main surface 20B of the element body 20).

Note that the barrier layer 60 may be formed on at least one of the main surface 20A of the element body 20 or the side surface 20C of the element body 20 instead of the main surface 20B of the element body 20 or in addition to the main surface 20B of the element body 20. The barrier layer 60 may be provided in accordance with the number of identification marks 70. For example, when the ceramic electronic component 10 includes a plurality of identification marks 70, the barrier layer 60 may be provided corresponding to each identification mark 70.

The barrier layer 60 has a quadrangular shape when viewed from the thickness direction 100, but the shape is not limited to the quadrangular shape. For example, the barrier layer 60 may have a circular shape when viewed from the thickness direction 100.

Similarly to the element body 20, the barrier layer 60 is includes ceramic as a main material. In the first embodiment, similarly to the element body 20, the barrier layer 60 is a main material and includes a filler for determining dielectric properties, a glass material, and an additive for adjusting physical properties such as shrinkage rate. However, the proportion of the glass material included in the barrier layer 60 is higher than the proportion of the glass material included in the element body 20. In the first embodiment, the proportion of the glass material included in the barrier layer 60 is 20% or more, which is higher than the proportion (10%) of the glass material included in the element body 20.

The proportion of the filler and the additive included in the barrier layer 60 is appropriately determined. For example, when the proportion of the glass material included in the barrier layer 60 is 25%, 75% excluding the glass material is allocated to the proportion of the filler and the additive included in the barrier layer 60. For example, similarly to the element body 20, 75% is allocated so that the proportion of the filler is twice the ratio of the additive, the proportion of the filler is 50%, and the proportion of the additive is 25%.

Similarly to the element body 20, the filler and the additive of the barrier layer 60 include aluminum (Al), magnesium (Mg), silicon (Si), barium (Ba), titanium (Ti), and the like. In the first embodiment, the filler and the additive of the barrier layer 60 include the same substance as the element body 20. That is, in the first embodiment, both the main material of the barrier layer 60 and the main material of the element body 20 are ceramics, and furthermore, the ceramics include the same substance. In other words, in the first embodiment, the main material of the barrier layer 60 is the same as the main material of the element body 20.

Similarly to the element body 20, as long as a condition that the main material is ceramic is satisfied, the material included in the barrier layer 60 is not limited to the above materials, and the proportion of each material included in the barrier layer 60 is not limited to the above proportion. The filler and the additive of the barrier layer 60 may include substances other than the above substances. In addition, the filler and the additive of the barrier layer 60 may include a substance different from the filler and the additive of the element body 20. That is, in the first embodiment, both the main material of the barrier layer 60 and the main material of the element body 20 are ceramics, but the ceramics may include mutually different substances. In other words, the main material of the barrier layer may be different from the main material of the element body 20.

A porosity of the barrier layer 60 is lower than a porosity of the element body 20. In other words, the barrier layer 60 is configured to be denser than the element body 20. The porosity of the barrier layer 60 is a volume ratio of a cavity to a total volume of the barrier layer 60. Similarly, the porosity of the element body 20 is the volume ratio of the cavity to a total volume of the element body 20.

The barrier layer 60 is provided on the main surface 20B of the element body 20. Note that the barrier layer 60 may be formed on the main surface 20B of the element body 20 by various known methods other than printing.

The identification mark 70 is formed on a surface 60B of the barrier layer 60 formed on the main surface 20B of the element body 20. The identification mark 70 is for indicating an orientation and direction of the ceramic electronic component 10.

In the first embodiment, the ceramic electronic component 10 includes one identification mark 70, but may include a plurality of identification marks 70.

In the first embodiment, as illustrated in FIG. 1, the identification mark 70 has a circular shape when viewed from the thickness direction 100, but the shape is not limited to a circular shape.

In the first embodiment, an outer edge portion 70A of the identification mark 70 is located inside of an outer edge portion 60A of the barrier layer 60 when viewed from the thickness direction 100. The outer edge portion 70A of the identification mark 70 is a part including an outer edge of the identification mark 70 and a vicinity of the outer edge when viewed from the thickness direction 100. The outer edge portion 60A of the barrier layer 60 is a part including an outer edge of the barrier layer 60 and a vicinity of the outer edge when viewed from the thickness direction 100.

Note that the outer edge portion 70A of the identification mark 70 is not required to be located inside of the outer edge portion 60A of the barrier layer 60 when viewed from the thickness direction 100. That is, the outer edge portion 70A of the identification mark 70 may overlap the outer edge portion 60A of the barrier layer 60 when viewed from the thickness direction 100. In this case, the identification mark 70 and the barrier layer 60 have the same shape and the same size when viewed from the thickness direction 100.

In each drawing, the color of the identification mark 70 is indicated by white or hatching, but the color of the identification mark 70 is not limited to white, and may be other colors such as black, gray, or red. The color of the identification mark 70 is preferably a color different from the color of a periphery of the identification mark 70 (the barrier layer 60 in the first embodiment).

In the first embodiment, the identification mark 70 includes ceramic as a main material, and includes alumina as a main material and a glass material. The proportion of each material included in the identification mark 70 is about 75% for alumina and about 25% for a glass material. In the first embodiment, the proportion of the glass material included in the identification mark 70 is larger than the proportion of the glass material included in the barrier layer 60 and the proportion of the glass material included in the element body 20.

Note that the material of the identification mark 70 is arbitrary on the condition that the material has high distinguishability (high visibility) from the periphery of the identification mark 70 (the barrier layer 60 in the first embodiment). For example, the identification mark 70 may include resin, metal, or the like as a main material. That is, the main material of the identification mark 70 may be other than ceramic. The proportion of the glass material included in the identification mark 70 may be smaller than the proportion of the glass material included in the barrier layer 60 and may be smaller than the proportion of the glass material included in the element body 20. The identification mark 70 is not required to include a glass material. The identification mark 70 may include a coloring material for making the identification mark 70 different in color from the barrier layer 60. As the coloring material, for example, a black ceramic such as zinc oxide (ZnO) or a white ceramic such as aluminum oxide (Al₂O₃) is used.

In the first embodiment, the element body 20, the barrier layer 60, and the identification mark 70 all include a glass material. The glass material included in the element body 20, the glass material included in the barrier layer 60, and the glass material included in the identification mark 70 are of the same type. The glass material included in the element body 20, the glass material included in the barrier layer 60, and the glass material included in the identification mark 70 are all borosilicate glass, for example.

Note that the glass material included in the element body 20, the glass material included in the barrier layer 60, and the glass material included in the identification mark 70 may be of different types. For example, while the glass material included in the element body 20 and the barrier layer 60 may be borosilicate glass, the glass material included in the identification mark 70 may be silicate glass.

As illustrated in FIG. 2, the plating layer 80 covers the external electrode 50. The plating layer 80 suppresses an influence of atmosphere, moisture, and the like on the external electrode 50. The plating layer 80 is a film including, for example, Ni (nickel)-Sn (tin), Ni (nickel)-electroless Au (gold), or the like. In the first embodiment, the plating layer 80 includes an inner layer 81 including nickel and an outer layer 82 including gold. The inner layer 81 is formed on a surface of the external electrode 50. The outer layer 82 is formed on the inner layer 81 on an opposite side of the external electrode 50.

In the first embodiment, the plating layer 80 includes two layers (the inner layer 81 and the outer layer 82), but the plating layer 80 may include one layer or three or more layers.

As described above, in the first embodiment, the proportion of each material included in the element body 20 is about 60% for the filler, about 10% for the glass material, and about 30% for the additive. The proportion of the glass material included in the barrier layer 60 is 20% or more. The proportion of each material included in the identification mark 70 is about 75% for alumina and about 25% for a glass material. That is, in the first embodiment, the composition ratios of the element body 20, the barrier layer 60, and the identification mark 70 are different from each other. However, the composition ratios of at least two of the element body 20, the barrier layer 60, or the identification mark 70 may be the same.

In the first embodiment, the barrier layer 60 is interposed between the element body 20 and the identification mark 70. As a result, the barrier layer 60 can prevent a diffusion of the identification mark 70 from reaching the element body 20. In addition, the action of stress from the identification mark 70 to the element body 20 can be absorbed by the barrier layer 60.

In the first embodiment, both the element body 20 and the barrier layer 60 include ceramic as a main material. Therefore, the action of diffusion and stress between the barrier layer 60 and the element body 20 can be reduced. As a result, the possibility of occurrence of cracks in the barrier layer 60 and the element body 20 and detachment of the barrier layer 60 from the element body 20 can be reduced.

In the first embodiment, the proportion of the glass material included in the barrier layer 60 is higher than the proportion of the glass material included in the element body 20. Therefore, the barrier layer 60 can be sintered more densely than the element body 20. As a result, an entry of a liquid into the element body 20 starting from the identification mark 70 can be reduced by the barrier layer 60.

When the shape and size of the identification mark 70 and the barrier layer 60 are the same as viewed from the thickness direction 100, that is, when the outer edge portion 70A of the identification mark 70 and the outer edge portion 60A of the barrier layer 60 are at the same position as viewed from the thickness direction 100, the outer edge portion 70A of the identification mark 70 is located near the main surface 20B of the element body 20. This configuration increases the possibility that the diffusion of the identification mark 70 reaches the element body 20, the possibility that the stress of the identification mark 70 acts on the element body 20, and the possibility that the liquid attached to the identification mark 70 reaches the element body 20. In the first embodiment, the outer edge portion 70A of the identification mark 70 is located inside of the outer edge portion 60A of the barrier layer 60 when viewed from the thickness direction 100. As a result, since the outer edge portion 70A of the identification mark 70 is distant from the main surface 20B of the element body 20, the possibility can be reduced.

In the first embodiment, both the main material of the identification mark 70 and the main material of the barrier layer 60 are ceramics. Therefore, adhesion of the identification mark 70 to the barrier layer 60 can be enhanced. As a result, the possibility of detachment of the identification mark 70 from the barrier layer 60 can be reduced.

In the first embodiment, since the porosity of the barrier layer 60 is lower than the porosity of the element body 20, it is possible to suppress the entry of the liquid into the element body 20 starting from the identification mark 70 in the barrier layer 60.

In the first embodiment, the main material of the barrier layer 60 is the same as the main material of the element body 20. Therefore, the adhesion of the barrier layer 60 to the element body 20 can be enhanced as compared with a configuration in which the main material of the barrier layer 60 is different from the main material of the element body 20.

In the first embodiment, the identification mark 70 includes a glass material. Therefore, sinterability of the identification mark 70 can be enhanced. As a result, it is possible to reduce the entry of liquid into the identification mark 70.

When the glass material included in the element body 20 and the glass material included in the barrier layer 60 are of different types, glass is absorbed from one of the element body 20 or the barrier layer 60 to the other. Similarly, when the glass material included in the barrier layer 60 and the glass material included in the identification mark 70 are of different types, glass is absorbed from one of the barrier layer 60 or the identification mark 70 to the other. As a result, diffusion between the element body 20, the barrier layer 60, and the identification mark 70 is promoted. In the first embodiment, the glass material included in the element body 20, the glass material included in the barrier layer 60, and the glass material included in the identification mark 70 are of the same type. Therefore, the diffusion can be suppressed.

In the first embodiment, the identification mark 70 can have a different color from the barrier layer 60 and the element body 20 by the coloring material. Therefore, visibility of the identification mark 70 can be enhanced.

### Method of Manufacturing Ceramic Electronic Component According to First Embodiment

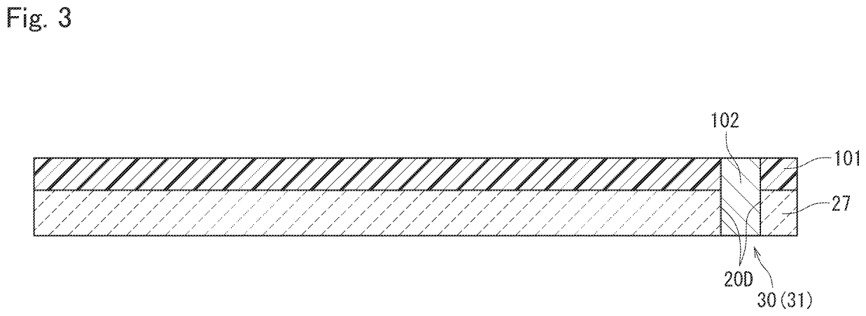

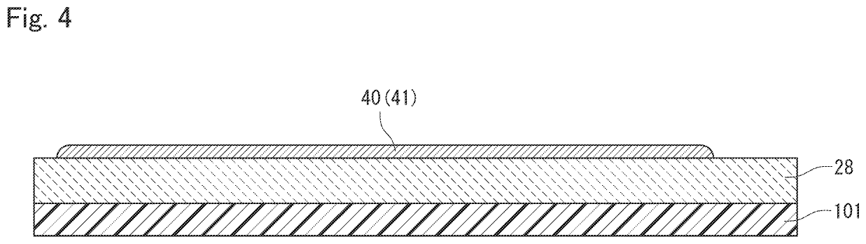

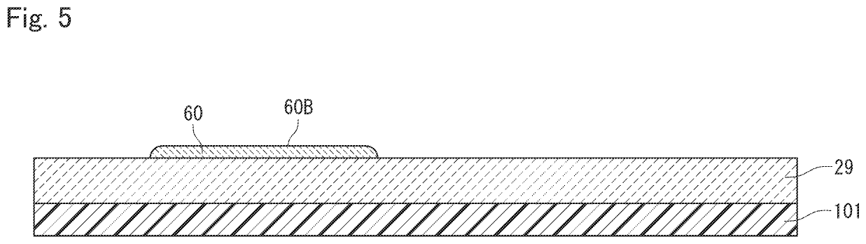

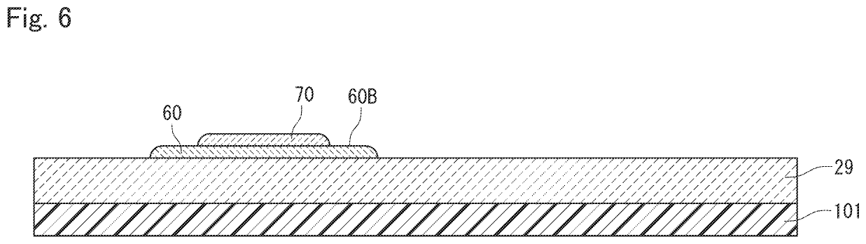

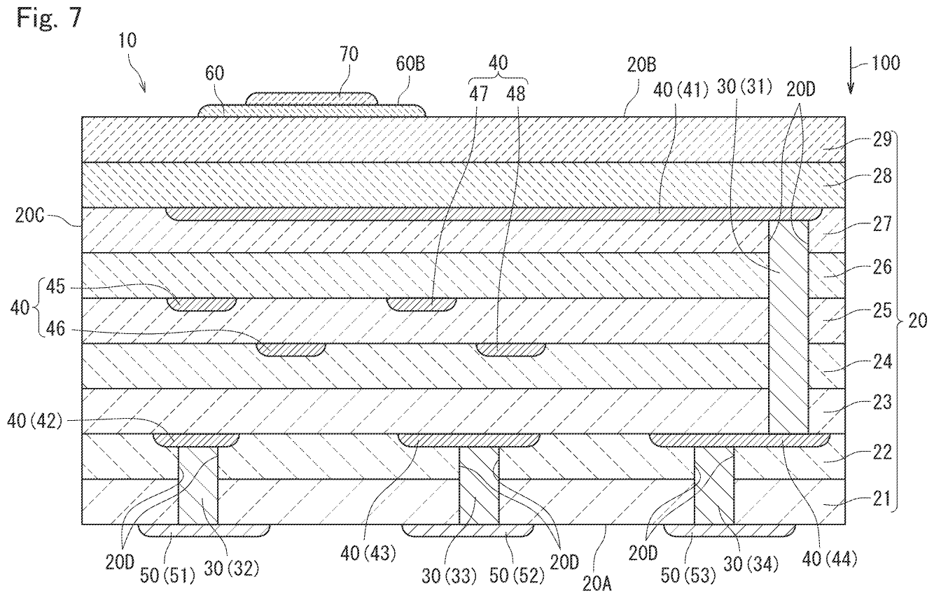

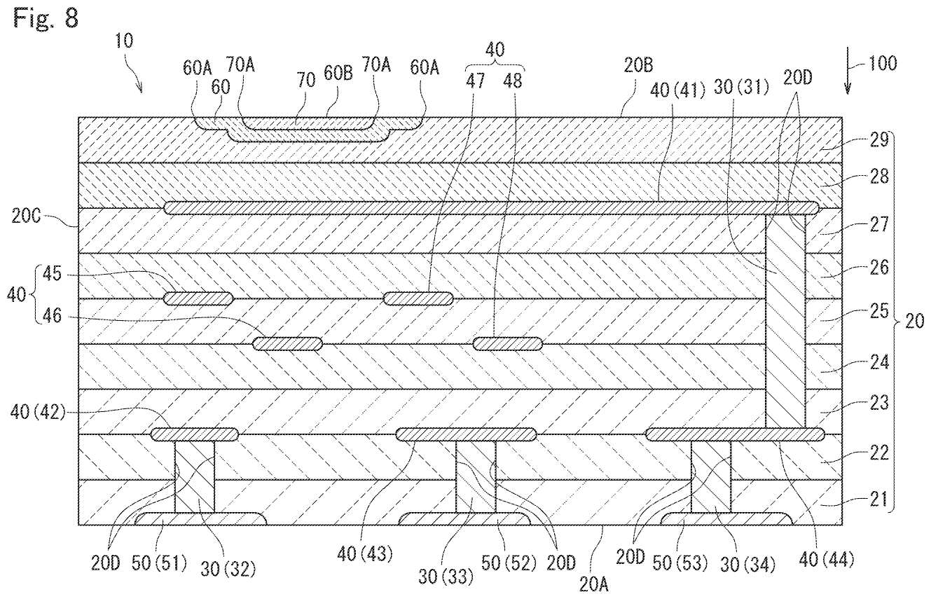

Hereinafter, a method of manufacturing the ceramic electronic component 10 according to the first embodiment will be described with reference to FIGS. 3 to 8. FIG. 3 is a sectional view when an interlayer connection conductor is formed on a substrate in a process of manufacturing the ceramic electronic component according to the embodiment of the present disclosure. FIG. 4 is a sectional view when an internal electrode is printed on the substrate in the process of manufacturing the ceramic electronic component according to the embodiment of the present disclosure. FIG. 5 is a sectional view when a barrier layer is printed on the substrate in the process of manufacturing the ceramic electronic component according to the embodiment of the present disclosure. FIG. 6 is a sectional view when an identification mark is printed on the barrier layer in the process of manufacturing the ceramic electronic component according to the embodiment of the present disclosure. FIG. 7 is a sectional view when a plurality of substrates are stacked to form an element body in the process of manufacturing the ceramic electronic component according to the embodiment of the present disclosure. FIG. 8 is a sectional view when the element body is crimped in the process of manufacturing the ceramic electronic component according to the embodiment of the present disclosure.

The ceramic electronic component 10 is manufactured by singulating a stacked body into a plurality of element bodies 20. The stacked body is formed by integrating the plurality of element bodies 20 in an arranged state. FIGS. 3 to 8 illustrates, for convenience of description, only a part of the stacked body corresponding to one element body 20. The method of manufacturing the ceramic electronic component 10 according to the first embodiment includes a sheet forming step, an interlayer connection conductor forming step, an electrode forming step, a barrier layer forming step, an identification mark forming step, an element body forming step, a crimping step, a singulation step, a firing step, and a plating layer stacking step.

### (Sheet Forming Step)

First, a sheet forming step is executed. In the sheet forming step, the substrates 21 to 29 illustrated in FIG. 2 are formed individually. In the substrates 21 to 29 formed in the sheet forming step, raw materials including a main agent, a plasticizer, a binder, and the like corresponding to each substrate 21 to 29 are mixed to prepare a slurry constituting each substrate 21 to 29. Each substrate 21 to 29 at this stage is a green sheet including the slurry.

For each substrate 21 to 29, for example, a sinterable ceramic powder or the like is used as the main agent. As the plasticizer, for example, phthalic acid ester or di-n-butyl phthalate is used. As the binder, for example, an acrylic resin, polyvinyl butyral, or the like is used.

The slurry constituting each substrate 21 to 29 is formed into a sheet shape on a carrier film 101 illustrated in FIG. 3 by using, for example, a lip coater, a doctor blade, or the like. That is, each of the nine substrates 21 to 29 is formed on each of the nine carrier films 101. As the carrier film 101, for example, a polyethylene terephthalate (PET) film or the like is used. The thickness of each substrate 21 to 29 is, for example, from 5 μm to 100 μm.

FIG. 3 illustrates the carrier film 101 and the substrate 27 formed on the carrier film 101.

Next, the through hole 20D penetrating each substrate 21 to 29 and the carrier film 101 in the thickness direction is formed.

In FIG. 3, one through hole 20D is formed in the substrate 27 and the carrier film 101, but the number of through holes 20D formed in each substrate 21 to 29 is not limited to one. The number of through holes 20D formed in the substrate 21 to 29 may be the same or different. The positions of through holes 20D formed in the substrate 21 to 29 may be the same position or different positions.

In the method of manufacturing the ceramic electronic component 10 according to the first embodiment, the number and positions of the through holes 20D formed in the nine substrates 21 to 29 and the carrier film 101 are determined such that the element body 20 as illustrated in FIG. 2 is finally formed.

### (Interlayer Connection Conductor Forming Step)

Next, the interlayer connection conductor forming step is executed. In the interlayer connection conductor forming step, a conductive paste 102 is filled in the through hole 20D formed in each substrate 21 to 29 and the carrier film 101 in the sheet forming step (see FIG. 3). The paste 102 filled in the through hole 20D corresponds to the interlayer connection conductor 30.

The paste 102 is prepared, for example, by mixing raw materials including a conductive powder, a plasticizer, and a binder.

### (Electrode Forming Step)

Next, the electrode forming step is executed. In the electrode forming step, the internal electrode 40 and the external electrode 50 are formed.

In the method of manufacturing the ceramic electronic component 10 according to the first embodiment, for example, as illustrated in FIG. 4, a paste corresponding to the internal electrode 41 is formed on the main surface of the substrate 28. The paste is formed by, for example, screen printing, inkjet printing, gravure printing, or the like. Other internal electrodes 40 (internal electrodes 42 to 48) and the external electrodes 50 are also formed on each substrate 21 to 29 similarly to the internal electrodes 41.

A paste corresponding to the internal electrode 40 and the external electrode 50 is prepared by mixing mainly raw materials including a conductive powder, a plasticizer, and a binder, similarly to the paste 102 described above. The paste corresponding to the internal electrode 40 and the external electrode 50 may include the same raw material as the paste 102, or may include a raw material different from the paste 102.

### (Barrier Layer Forming Step)

Next, the barrier layer forming step is executed. In the barrier layer forming step, the barrier layer 60 is formed.

In the method of manufacturing the ceramic electronic component 10 according to the first embodiment, as illustrated in FIG. 5, a paste corresponding to the barrier layer 60 is formed on the main surface of the substrate 29. The paste corresponding to the barrier layer 60 is formed by, for example, screen printing, inkjet printing, gravure printing, a transfer method described later, or the like.

The paste corresponding to the barrier layer 60 includes the material constituting the barrier layer 60 described above. The composition of the material of the barrier layer 60 is determined so as to be sintered with the element body 20 (the substrate 29 in the first embodiment) and the identification mark 70. For example, when the barrier layer 60 is low temperature co-fired ceramics (LTCC), the compatibility of the ceramic and the glass material included in the barrier layer 60 with the materials of the element body 20 and the identification mark 70 is matched. For example, individual optimization is performed in consideration of factors such as shrinkage behavior, electrical characteristics, thermal expansion coefficient, and sinterability. The proportion of the glass material included in the barrier layer 60 is higher than the proportion of the glass material included in the element body 20. In this manner, the sinterability and denseness of the barrier layer 60 are improved.

The barrier layer 60 forming step may be executed before the electrode forming step.

### (Identification Mark Forming Step)

Next, the identification mark forming step is executed. In the identification mark forming step, the identification mark 70 is formed.

In the method of manufacturing the ceramic electronic component 10 according to the first embodiment, as illustrated in FIG. 6, a paste corresponding to the identification mark 70 is formed on the surface 60B of the barrier layer 60 formed on the main surface of the substrate 29 in the barrier layer forming step. The paste corresponding to the identification mark 70 is formed by, for example, screen printing, inkjet printing, gravure printing, a transfer method described later, or the like. The paste corresponding to the identification mark 70 includes the material constituting the identification mark 70 described above. As described above, the material of the identification mark 70 is arbitrary. For example, when identification mark 70 includes a conductive material, the paste corresponding to the identification mark 70 is a conductive paste, and when the identification mark 70 does not include a conductive material, the paste corresponding to the identification mark 70 is a non-conductive paste.

### (Element Body Forming Step)

Next, the element body forming step is executed. In the element body forming step, as illustrated in FIG. 7, the substrates 21 to 29 excluding the carrier film 101 are stacked. As a result, the element body 20 is obtained.

In the element body forming step, the nine substrates 21 to 29 are stacked in the order from a substrate having a smaller numerical value to a substrate having a larger numerical value, specifically, in the order of substrates 21, 22, 23, 24, 25, 26, 27, 28, and 29. As a result, the main surface of the substrate 21 becomes the main surface 20A of the element body 20, and the main surface of the substrate 29 becomes the main surface 20B of the element body 20. In addition, the side surfaces of the substrates 21 to 29 become the side surface 20C of the element body 20.

In the first embodiment, some of the nine substrates 21 to 29 are inverted with respect to the others of the nine substrates 21 to 29 and stacked. In the example illustrated in FIG. 7, the substrates 21 to 28 are stacked with the surface near the carrier film 101 facing upward in the drawing, and the substrate 29 is stacked with the surface near the carrier film 101 facing downward in the drawing. As a result, as illustrated in FIG. 7, each of the internal electrode 40 and the external electrode 50 formed on the substrates 21, 23, 25, 26, and 28 is located below each of the substrates 21, 23, 25, 26, and 28, and the barrier layer 60 and the identification mark 70 formed on the substrate 29 are located above the substrate 29.

### (Crimping Step)

Next, the crimping step is executed. In the crimping step, the stacked substrates 21 to 29 are crimped in a mold.

By crimping the substrates 21 to 29, as illustrated in FIG. 8, the internal electrode 40 enters the substrates 23, 25, 26, and 28, the external electrode 50 enters the substrate 21, and the barrier layer 60 enters the substrate 29. In addition, the identification mark 70 enters the barrier layer 60 and enters the substrate 29 together with the barrier layer 60. As a result, the barrier layer 60 and the identification mark 70 are embedded in the element body 20.

Note that the crimping step is not required to be executed. In this case, the barrier layer 60 and the identification mark 70 are not embedded in the element body 20.

(Singulation step)

Next, the singulation step is executed. In the singulation step, the stacked body in which the plurality of element bodies 20 are arranged is cut into the plurality of element bodies 20. For cutting the stacked body, for example, a dicing saw, a guillotine cutter, a laser, or the like is used. After the stacked body is cut, the corners and the edges of the element body 20 may be polished by, for example, barrel processing or the like (see FIG. 2). The polishing may be executed after the firing step.

### (Firing Step)

Next, the firing step is executed. In the firing step, the substrates 21 to 29 are fired to form the element body 20 as a sintered body (see FIG. 2).

### (Plating Layer Stacking Step)

Next, a plating layer stacking step is executed. In the plating layer stacking step, the external electrode 50 is subjected to a known plating treatment. As a result, as illustrated in FIG. 2, the plating layer 80 is stacked so as to cover the external electrode 50.

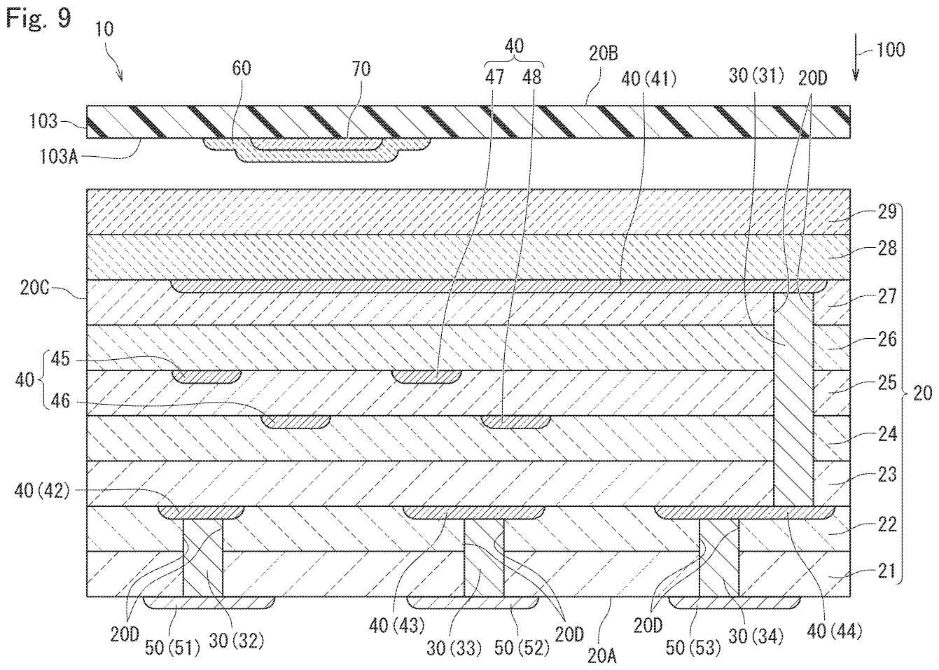

FIG. 9 is a sectional view of a plurality of stacked substrates and a film on which a barrier layer and an identification mark are printed in a modification of the process of manufacturing the ceramic electronic component according to the embodiment of the present disclosure. The barrier layer 60 and the identification mark 70 may be formed on the substrate 29 by the transfer method.

In the case of the transfer method, as illustrated in FIG. 9, the identification mark 70 is printed on a main surface 103A of a transfer sheet 103, and then the barrier layer 60 is printed so as to cover the identification mark 70 on the transfer sheet 103. Thereafter, in the element body forming step, the transfer sheet 103 is stacked on the substrate 29 such that the main surface 103A of the transfer sheet 103 faces the substrate 29. As a result, the barrier layer 60 and the identification mark 70 are transferred from the transfer sheet 103 to the substrate 29.

### Second Embodiment

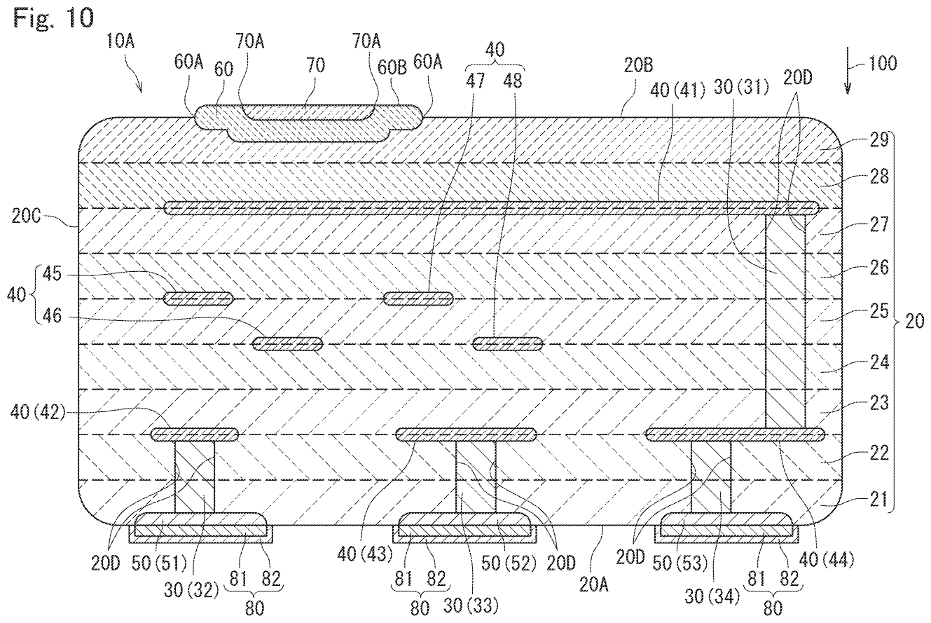

FIG. 10 is a sectional view corresponding to the cross section taken along line A-A of FIG. 1 in a ceramic electronic component according to a second embodiment of the present disclosure. A ceramic electronic component 10A according to the second embodiment is different from the ceramic electronic component 10 according to the first embodiment in that the barrier layer 60 protrudes from the main surface 20B of the element body 20. Hereinafter, the difference from the first embodiment will be described. Common points with the ceramic electronic component 10 according to the first embodiment are denoted by the same reference numerals, and the description thereof will be omitted in principle and described as necessary.

As illustrated in FIG. 10, in the ceramic electronic component 10A, the barrier layer 60 protrudes from the main surface 20B of the element body 20.

In the configuration illustrated in FIG. 10, a part of the barrier layer 60 in the thickness direction 100 is embedded in the element body 20, and the other parts of the barrier layer 60 in the thickness direction 100 protrudes from the element body 20. However, the entire barrier layer 60 in the thickness direction 100 may protrude from the element body 20. In other words, the barrier layer 60 may be stacked on the substrate 29 without being embedded in the substrate 29.

In the configuration illustrated in FIG. 10, the entire region of the barrier layer 60 when viewed from the thickness direction 100 protrudes from the main surface 20B of the element body 20. However, only a partial region of the barrier layer 60 when viewed from the thickness direction 100 may protrude from the main surface 20B of the element body 20.

The configuration in which the barrier layer 60 protrudes from the main surface 20B of the element body 20 can be achieved, for example, by making the barrier layer 60 thick in the barrier layer forming step. For example, the barrier layer 60 is made thick by being printed in an overlapping manner a plurality of times in the barrier layer forming step. By making the barrier layer 60 thick, a configuration in which a part of the barrier layer 60 protrudes from the substrate 29 without being embedded in the substrate 29 can be easily achieved in the subsequent crimping step.

Alternatively, for example, the configuration in which the barrier layer 60 protrudes from the main surface 20B of the element body 20 can be achieved by reducing the pressure for pressing the substrate 29 in the crimping step.

Alternatively, for example, the configuration in which the barrier layer 60 protrudes from the main surface 20B of the element body 20 can be achieved by not executing the crimping step.

A plurality of the steps described above may be executed. For example, the barrier layer 60 may be made thick in the barrier layer forming step, and the pressure for pressing the substrate 29 may be reduced in the crimping step.

In the second embodiment, the distance between the identification mark 70 and the element body 20 can be increased in the thickness direction 100 as compared with the configuration in which the barrier layer 60 does not protrude from the main surface 20B of the element body 20. It is therefore possible to reduce the possibility that the diffusion of the identification mark 70 reaches the element body 20, the possibility that the stress of the identification mark 70 acts on the element body 20, and the possibility that the liquid attached to the identification mark 70 reaches the element body 20.

### Third Embodiment

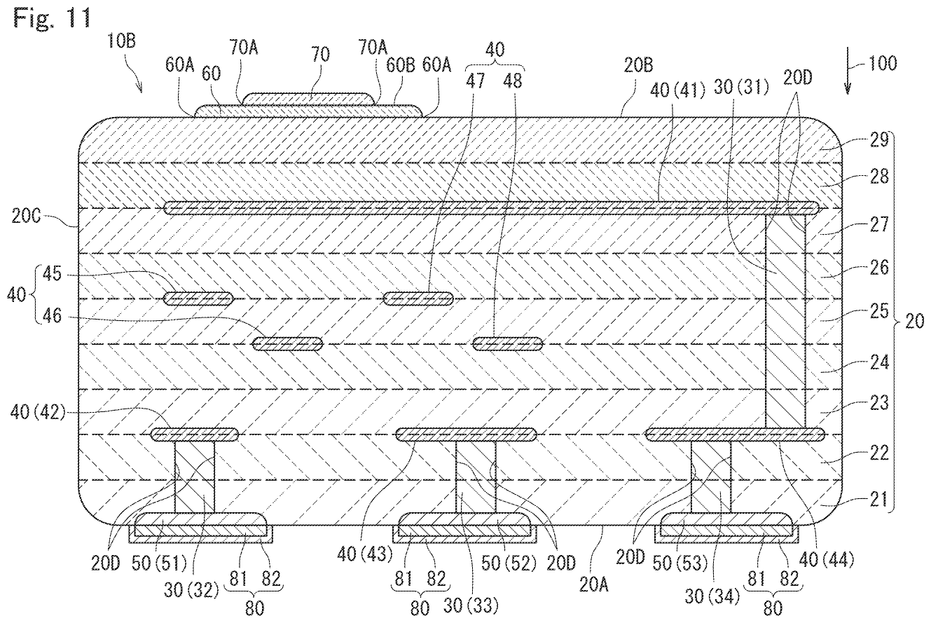

FIG. 11 is a sectional view corresponding to the cross section taken along line A-A of FIG. 1 in a ceramic electronic component according to a third embodiment of the present disclosure. A ceramic electronic component 10B according to the third embodiment is different from the ceramic electronic component 10 according to the first embodiment in that the identification mark 70 protrudes from the surface 60B of the barrier layer 60. Hereinafter, the difference from the first embodiment will be described. Common points with the ceramic electronic component 10 according to the first embodiment are denoted by the same reference numerals, and the description thereof will be omitted in principle and described as necessary.

As illustrated in FIG. 11, in the ceramic electronic component 10B, the identification mark 70 protrudes from the surface 60B of the barrier layer 60.

In the configuration illustrated in FIG. 11, the identification mark 70 is stacked on the barrier layer 60 without being embedded in the barrier layer 60, but a part of the identification mark 70 may be embedded in the barrier layer 60.

In the configuration illustrated in FIG. 10, the entire region of the identification mark 70 when viewed from the thickness direction 100 protrudes from the surface 60B of the barrier layer 60. However, only a partial region of the identification mark 70 when viewed from the thickness direction 100 may protrude from the surface 60B of the barrier layer 60.

The configuration in which the identification mark 70 protrudes from the surface 60B of the barrier layer 60 can be achieved, for example, by making the identification mark 70 thick in the identification mark forming step. For example, the identification mark 70 is made thick by being printed in an overlapping manner a plurality of times in the identification mark forming step. By making the identification mark 70 thick, a configuration in which a part of the identification mark 70 protrudes from the barrier layer 60 without being embedded in the barrier layer 60 can be achieved in the subsequent crimping step.

Alternatively, for example, the configuration in which the identification mark 70 protrudes from the surface 60B of the barrier layer 60 can be achieved by reducing the pressure for pressing the substrate 29 in the crimping step.

Alternatively, for example, the configuration in which the identification mark 70 protrudes from the surface 60B of the barrier layer 60 can be achieved by not executing the crimping step.

A plurality of the steps described above may be executed. For example, the identification mark 70 may be made thick in the identification mark forming step, and the pressure for pressing the substrate 29 may be reduced in the crimping step.

In the third embodiment, the distance between the identification mark 70 and the element body 20 can be increased in the thickness direction 100 as compared with the configuration in which the identification mark 70 does not protrude from the surface 60B of the barrier layer 60. It is therefore possible to reduce the possibility that the diffusion of the identification mark 70 reaches the element body 20, the possibility that the stress of the identification mark 70 acts on the element body 20, and the possibility that the liquid attached to the identification mark 70 reaches the element body 20.

Note that, by appropriately combining any embodiments of the various embodiments described above, the effects of each of the embodiments can be achieved.

Although the present disclosure has been sufficiently described in connection with preferred embodiments with reference to the drawings as appropriate, various modifications and corrections are apparent to those skilled in the art. It should be understood that such modifications and corrections are included within the scope of the present disclosure according to the appended claims as long as the modifications and corrections do not depart from the scope.
10 ceramic electronic component
20 element body
20B main surface (surface)
60 barrier layer
60A outer edge portion
60B surface
70 identification mark
70A outer edge portion
100 thickness direction (orthogonal direction)

What is claimed is:

1. A ceramic electronic component comprising:
an element body including ceramic as a main material;
a barrier layer provided on a part of a surface of the element body, embedded in the element body so as to be exposed to an outside of the element body, and including ceramic as a main material; and
an identification mark provided on a surface of the barrier layer,
wherein
the element body and the barrier layer comprise a glass material, and
a proportion of the glass material comprised in the barrier layer is higher than a proportion of the glass material comprised in the element body.

2. The ceramic electronic component according to claim 1, wherein
an outer edge portion of the identification mark is inside of an outer edge portion of the barrier layer when viewed from an orthogonal direction orthogonal to a surface of the element body on which the barrier layer is provided.

3. The ceramic electronic component according to claim 1, wherein
a main material of the identification mark is ceramic.

4. The ceramic electronic component according to claim 1, wherein
a porosity of the barrier layer are lower than a porosity of the element body.

5. The ceramic electronic component according to claim 1, wherein
the main material of the barrier layer is the same as the main material of the element body.

6. The ceramic electronic component according to claim 1, wherein
at least a part of the barrier layer protrudes from the surface of the element body.

7. The ceramic electronic component according to claim 1, wherein
at least a part of the identification mark protrudes from the surface of the barrier layer.

8. The ceramic electronic component according to claim 1, wherein
the identification mark comprises a glass material.

9. The ceramic electronic component according to claim 8, wherein
the glass material comprised in the element body, the glass material comprised in the barrier layer, and the glass material comprised in the identification mark are of the same type.

10. The ceramic electronic component according to claim 1, wherein
the identification mark comprises a coloring material.

11. The ceramic electronic component according to claim 2, wherein
a main material of the identification mark is ceramic.

12. The ceramic electronic component according to claim 2, wherein
a porosity of the barrier layer are lower than a porosity of the element body.

13. The ceramic electronic component according to claim 3, wherein
a porosity of the barrier layer are lower than a porosity of the element body.

14. The ceramic electronic component according to claim 2, wherein
the main material of the barrier layer is the same as the main material of the element body.

15. The ceramic electronic component according to claim 3, wherein
the main material of the barrier layer is the same as the main material of the element body.

16. The ceramic electronic component according to claim 4, wherein
the main material of the barrier layer is the same as the main material of the element body.

17. The ceramic electronic component according to claim 2, wherein
at least a part of the barrier layer protrudes from the surface of the element body.

18. The ceramic electronic component according to claim 3, wherein
at least a part of the barrier layer protrudes from the surface of the element body.

19. The ceramic electronic component according to claim 4, wherein
at least a part of the barrier layer protrudes from the surface of the element body.

20. The ceramic electronic component according to claim 5, wherein
at least a part of the barrier layer protrudes from the surface of the element body.
